(19) United States
(12) Patent Application Publication
(10) Pub. No.: US 2013/0212508 A1
(43) Pub. Date: Aug. 15, 2013

(54) SYSTEM, METHOD AND GRAPHICAL USER INTERFACE TO FACILITATE PROBLEM-ORIENTED MEDICAL CHARTING

(71) Applicants: Wael K. Barsoum, Bay Village, OH (US); Michael W. Kattan, Cleveland, OH (US); William H. Morris, Shaker Heights, OH (US); Douglas R. Johnston, Shaker Heights, OH (US)

(72) Inventors: Wael K. Barsoum, Bay Village, OH (US); Michael W. Kattan, Cleveland, OH (US); William H. Morris, Shaker Heights, OH (US); Douglas R. Johnston, Shaker Heights, OH (US)

(73) Assignee: THE CLEVELAND CLINIC FOUNDATION, Cleveland, OH (US)

(21) Appl. No.: 13/587,440

(22) Filed: Aug. 16, 2012

Related U.S. Application Data
(60) Provisional application No. 61/523,913, filed on Aug. 16, 2011.

(51) Int. Cl. G06F 19/00

(52) U.S. Cl. CPC G06F 19/30
USPC 715/771

(57) ABSTRACT

This disclosure relates to systems and methods for providing analytics for an enterprise workflow, such as to characterize employee behavior based on enterprise data collected based on services performed by the employees. The system can be utilized, for example, to help drive proper documentation by employees of the enterprise, such as by generating statistics that characterize documentation entered by or on behalf of an employee or a group of employees for services that have been performed.

### CROSS-REFERENCE TO RELATED APPLICATION

This application claims the benefit to U.S. Provisional Patent Application Ser. No. 61/523,913, filed Aug. 16, 2011 and entitled SYSTEM, METHOD AND GRAPHICAL USER INTERFACE TO FACILITATE ACCURATE PROBLEM-ORIENTED MEDICAL CHARTING, which is incorporated herein by reference in its entirety.

### BACKGROUND

In the healthcare industry, it is customary for providers (e.g., physicians, clinicians, nurses or other practitioners) to document a diagnosis or problem statement in an electronic health record for a patient. Based upon the documentation entered by the provider, the encounter can be coded (e.g., by a coder) for billing purposes. The accuracy of such documentation can vary from provider to provider—even within a given institution—despite well documented procedures that should be followed.

### SUMMARY

This disclosure provides a system, method and graphical user interface (GUI) such as can be utilized to facilitate accurate problem-oriented medical charting and influence behavior or providers.

As one example, a system can include memory to store computer executable instructions and enterprise data. The enterprise data can include customer data representing information to document services rendered by a given enterprise provider for each customer (e.g., patients). A processor can be configured to access the memory and execute the computer executable instructions. The instructions can include an analytics engine to compute descriptive statistics relating to the services rendered by one or more providers based on problems documented by the providers in the customer data (e.g., in a problem list). Output controls can generate an output of the descriptive statistics.

As another example, a non-transitory medium having machine readable instructions can be programmed for performing a method that includes accessing documentation data, the documentation data including information entered by or on behalf of a healthcare service provider in relation to at least one of patient treatment or management. Descriptive statistics can be computed for a documentation behavior of the provider based on analysis the documentation data, including the information entered by or on behalf of the provider. An output can be generated to present a representation of the computed descriptive statistics.

### BRIEF DESCRIPTION OF THE DRAWINGS

FIG. 1 depicts an example of a system that can be implemented.

FIG. 2 is an example of a graphical user interface demonstrating an average number of problems per patient by all providers.

FIG. 3 depicts an example of a graphical user interface demonstrating an average number of problems per patient by all providers, including problem updates.

FIG. 4 is an example of a graphical user interface demonstrating an average numbers of problems per patient in a selected service line.

FIG. 5 depicts an example of a graphical user interface demonstrating an average number of problems over a selected time period for a selected provider.

FIG. 6 depicts an example of a graphical user interface demonstrating comparative statistics for a selected service line.

FIGS. 7A and 7B depicts an example of a graphical user interface demonstrating descriptive statistics that can be generated for a selected patient over a selected time period.

FIG. 8 depicts an example of a graphical user interface demonstrating a detailed indication of problem lists for a selected patient.

FIG. 9 depicts an example of a graphical user interface demonstrating an enterprise level chart of descriptive statistics relating to severity and percentage of problems that have been updated within a selected time period.

FIG. 10 depicts an example of a graphical user interface demonstrating descriptive statistics that can be generated for a selected service line of an enterprise.

FIG. 11 depicts an example of a graphical user interface demonstrating trending of descriptive statistics over a selected time period.

FIG. 12 depicts an example of a graphical user interface demonstrating descriptive statistics for a selected service line (from FIG. 11).

FIG. 13 depicts an example of a graphical user interface demonstrating comparative statistics that can be generated.

FIG. 14 depicts an example of a graphical user interface demonstrating enterprise level descriptive statistics that can be generated for patients.

FIG. 15 depicts an example of a graphical user interface demonstrating tools that can be utilized for customizing reports.

FIG. 16 depicts an example of a graphical user interface demonstrating an interactive report that can be generated for alerting users about certain patient conditions based on computed statistics.

FIG. 17 depicts an example of a graphical user interface demonstrating a score card for provider level comparative statistics.

FIG. 18 depicts another example of a graphical user interface demonstrating a score card for provider level comparative statistics.

FIG. 19 depicts an example of a graphical user interface demonstrating statistics on how frequently a given provider updates problems.

FIG. 20 depicts an example of a rules-based tool that can be employed to facilitate assessing documentation and billing behaviors of providers.

### DETAILED DESCRIPTION

This disclosure provides a system, method and graphical user interface (GUI). The approach disclosed herein can facilitate accurate problem-oriented medical charting by assessing the behavior of providers, including documentation behavior and/or billing behavior.

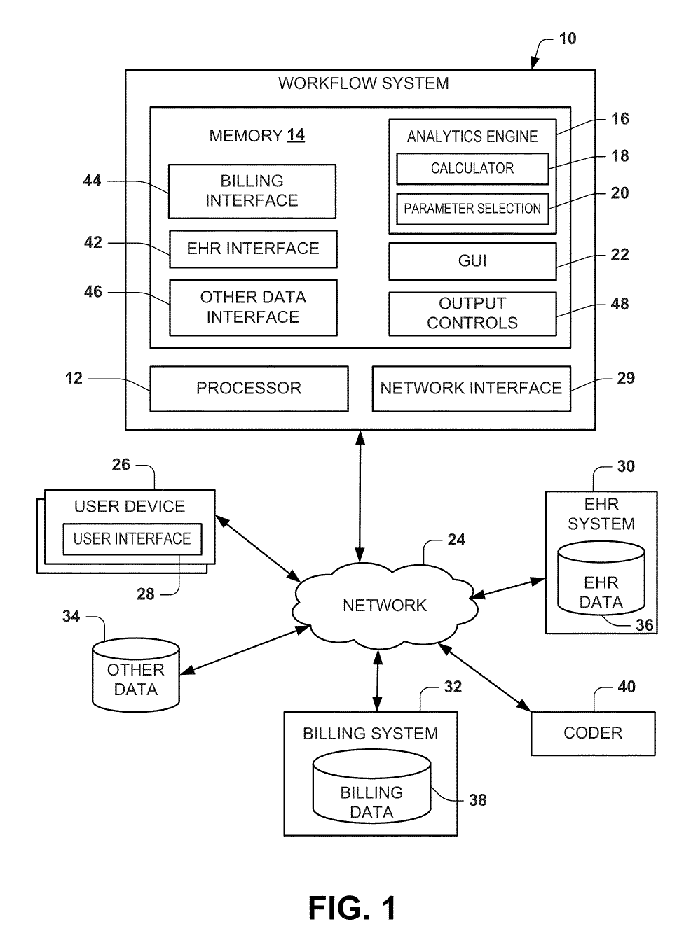

FIG. 1 depicts an example of a system 10 that can be employed to facilitate problem-oriented medical charting. The system 10 can be implemented to provide analytics for an enterprise workflow and its providers based on enterprise data collected by one or more enterprise repository. The system 10 can be utilized, for example, to help drive proper documentation by employees of the enterprise, such as by generating statistics that characterize documentation entered by or on behalf of an employee or a group of employees for services performed for customers. For an enterprise where the documentation translates (directly or indirectly) to revenue, such as in the healthcare industry, the system 10 can generate an output (e.g., comprising a report, graph, a chart or the like) that can help influence behavior of employees to enable the enterprise to capture potential revenue opportunities that might otherwise be lost due to inaccurate or incomplete documentation for services that are rendered by the employee(s).

For the example of a healthcare enterprise, the system 10 can generate output statistics demonstrating how well a given provider (e.g., doctor, nurse, or other practitioner) may document treatment and/or management of a patient. The system 10 can generate such output statistics for an individual provider or it can be generated for a group of providers to show how each provider or group of providers documents their services relative to each other provider. This can be utilized as motivation to influence such providers to more accurately document treatment, management and other services that are performed on patients. In addition to addressing some fiscal concerns, the system 10 can also address reputational issues (e.g., relating to a provider, a service line or, more generally, the enterprise as a whole), which can be identified through analysis performed by the system 10 based on enterprise data.

Additionally, the system 10 can compare different types of related behaviors of employees or groups of employees and identify anomalies. As an example, the system 10 can compare documentation behavior (e.g., according to documentation entered by an employee or group of employees) with billing behaviors (e.g., according to billing data for such employee or group of employees) and generate an output that identifies anomalies between such behavioral data. For example, the system 10 could identify a patient who does not have a diagnosis for diabetes but does have insulin as a medication. This and other types of analytics for comparing related data can be programmed by a user via tools implemented within the system 10.

Turning to the example of FIG. 1, the system 10 includes a processor 12 and memory 14, such as can be implemented in a server or other computer or arrangement of computers. The memory 14 can be implemented as non-transitory medium configured to store computer readable instructions and data. The processor 12 can access the memory 14 for executing the computer executable instructions, such as for performing the functions and methods disclosed herein.

In the example of FIG. 1, the memory 14 includes computer executable instructions comprising an analytics engine 16. The analytics engine 16 can include a calculator 18 that can be programmed to compute statistics based on enterprise data and input selected parameters. The calculator 18 can be programmed to compute descriptive statistics (e.g., to provide a summary characterizing of selected enterprise data), inferential statistics (e.g., to draw or infer conclusions from the selected enterprise data, such as based on probability theory) or a combination different types of statistics as may vary according to application requirements.

To select or otherwise establish parameters for such computations, the analytics engine 16 can include a parameter selection component 20. The parameter selection component 20 can be employed to select and configure parameters, in response to a user input, for use by the calculator 18 in computing the output statistics. The system 10 thus can also include a graphical user interface (GUI) 22 that can provide user access to related functions and methods implemented by the system 10, including the analytics engine 16. The GUI 22 can also include a representation of the output statistics computed by the analytics engine 16. For example, an authorized user can employ the GUI 22 for defining parameters for data to be extracted from data sources (e.g., to identify one or more data sources of as well as the types, content and range of data to be extracted) for use in computing and displaying a representation of the output statistics.

One or more authorized users can access the system 10 locally or remotely over a network 24. For example, a user can employ a user device 26 that includes a corresponding user interface 28. The user can employ the user interface 28 to in turn access the functions and methods provided by the system 10, including the parameter selection 20 for setting the appropriate parameters associated with the data extraction process and activating the calculator 18. For example, the processor 12 can employ a network interface 29 that is coupled to the network 24 to access and retrieve the data from one or more sources of data. The network 26 can include a local area network (LAN), a wide area network (WAN), such as the internet or an enterprise intranet. The network 26 may further include physical communication media (e.g., optical fiber or electrically conductive wire), wireless media or a combination of physical and wireless communication media.

In one example, the calculator 18 can be programmed with mathematical and/or statistical methods to compute the statistics (e.g., descriptive and/or inferential) from the enterprise data. Computed statistics can represent a summary of selected enterprise data, represent correlations and comparisons between and among related enterprise data, as well as otherwise demonstrate inferences drawn from the enterprise data. For instance, descriptive statistics can provide an output corresponding to a simplified summary about a category of enterprise information (e.g., a performance metric) to enable comparisons across employees or other identifiable units (e.g., service lines, departments, providers, customers or the like) within the enterprise. For example, the performance metric can relate to how well an employee/provider documents services rendered for or on behalf of enterprise customers (e.g., patients). The services can include services performed by such employee/provider directly or indirectly (e.g., at his/her direction by other personnel). Since charges can be billed according to services performed, the documentation of such services can be a key component used for generating receivable revenues. The output can be graphically presented in the GUI 22 to visually demonstrate the computed statistics in an easily identifiable manner. For instance, outliers for a given statistic can be readily ascertained by the user and further details about such outliers (e.g., statistical anomalies) can be obtained by drilling down via the GUI 22, such as by selecting a corresponding GUI element that is linked to the information of interest.

The following examples are disclosed herein in the context of a medical enterprise (e.g., a hospital, clinic or other institution), such as where providers are doctors, nurses or other care givers, customers are patients, and a service line corresponds to a practice area or other logical grouping of providers within the enterprise. However, it will be understood that the underlying features are equally applicable to other types of enterprises, such as law firms, manufacturing firms, insurance firms and the like that may collect data sufficient to perform the various types of computations disclosed herein.

In the example of FIG. 1, the calculator 18 can obtain the enterprise data from one or more sources of data. The sources of data can include, for example, an electronic health record (EHR) system 30, a billing system 32 as well one or more other sources of data, indicated at 34. The other sources of data 34 can include any type of patient data that may contain information relating to a patient, a patient's stay, a patient's health condition, a patient's opinion of a healthcare facility and/or its personnel or demographics.

The EHR system 30 can include any one or more EHR systems that can be implemented within the hospital enterprise and thus collectively defines EHR data 36. The EHR data 36 can represent information for a plurality of different categories. By way of example, the categories of patient data in the EHR data 36 can include the following: patient demographic data; all patient refined (APR) severity information, APR diagnosis related group (DRG) information or codes, problem list codes, prescribed medications, and lab results.

Additionally, the billing system 32 may comprise final coded data 38, such as billing data 38. The final coded data 38 can include various categories of data, such as including final billing codes, final procedure codes and other final coded data. A coder 40 can generate the final coded data (e.g., stored as the other data 34) based on the EHR data 36 and/or other data 34. The coder 40 can be implemented as an automated method, a manual method or a combination of manual and automated methods. For example, the final coded data 38 can include International Classification of Diseases (ICD) data (e.g., ICD-9, ICD-10-CM or ICD-10-PCS), diagnosis-related group (DRG) data, (e.g., Medicare DRG, Refined DRG, all patient DRG, severity DRG, all patient severity-adjusted DRG, all patient refined DRG or International-refined DRG). Those skilled in the art will understand and appreciate other types and categories of information and coding that may be utilized to derive the final coded data 38.

The analytics engine 16 can employ respective interfaces (e.g., application program interfaces) 42, 44 and 46 to access the data sources. In the example of FIG. 1, an EHR interface 42 is programmed to access relevant data from the EHR system 30. A billing interface 44 is programmed for accessing relevant data from the billing system 32. Similarly, an other data interface 46 is programmed for accessing the other data source 34. The analytics engine 16 thus can utilize one or more such interfaces 42, 44 or 46 to retrieve selected data from the respective data sources according to selected parameters required for computing corresponding output statistics.

The system 10 also includes output controls 48 programmed to control a representation of the output statistics computed by the analytics engine 16. The output controls 48 can automatically generate a graphical representation of the output statistics based on the parameters set by the user via the parameter selection component 20, such that the appearance of the graphics is set for a given type of display. Alternatively, or additionally the user can employ the GUI 22 to select parameters to achieve a user-defined type and form of the output. The output can be presented as including text, graphics or a combination of text and graphics, which may be provided interactively within the GUI 22.

As a further example, the output controls 48 may control the representation as to be static or animated. An animated output can be provided for a set of parameters to demonstrate changes in the computed statistics for a given enterprise unit (e.g., patient, provider, service line, department, or the like) over a period of time. The output controls 44 can provide tools that allow a user to control the playback of the animated output (e.g., to pause, rewind, fast forward, reverse playback, etc.). In this way, temporal changes in desired statistics can be visualized in an interactive GUI 22 to demonstrate changes in the statistics over one or more selected periods of time. The amount of time or patient encounters for which the animation is displayed can be set by a given user, such as via the parameter selection component As a further example, the calculator 18 can include an opportunity calculator programmed to compute comparative statistics based on documentation entered by a provider and corresponding billing data. The opportunity calculator can compute comparative statistics to identify an anomaly between the documentation data and billing data, and the output controls can provide a corresponding output in the form of a graphical and/or text based output for a given provider. The opportunity calculator can further compute statistics over time for a set of patients serviced by the given provider, thereby providing an indication of documentation behavior that might differ from actual billing. In this way, feedback (e.g., in the form of a report or other notice) can be generated to alert the provider in an effort to modify his/her documentation behavior. The output controls 48, for example, can generate a report that compares one or more selected providers' documentation with actual billing behavior, as described in the billing data 38. Additionally or as an alternative to generating a report, the output controls 48 could send a message (e.g., email, text, page or the like) to the provider to suggest a possible update to the patient record in the EHR system 30 based on detecting an anomaly. The provider thus could update the patient record or otherwise confirm or reject the suggestion, such as via a link to the patient record that can be provided in the message.

As a further example, the opportunity calculator can be programmed to employ surrogate data or rules programmed to identify potential anomalies based on documentation data, billing data or a combination of documentation data and billing data. For example, the surrogate data can include a data set, such as can be implemented as including a look-up table or a rules engine, which is programmed based on institutional standards (e.g., accepted or best practices) to identify one or more related diagnoses or problems, medications or labs that have been determined to exist together. For instance, the billing data 38 or documentation data for a given patient encounter can be an input to the opportunity calculator that can utilize the surrogate data to determine if such an anomaly exists and generate and output identifying a possible missed opportunity. The opportunity calculator thus can be programmed to identify an anomaly in response to detecting that one or more descriptors or codes known to exist together (as defined in the surrogate data) is missing. As one example, for a patient who is prescribed or taking a given medication (e.g., insulin) but does not have a corresponding diagnosis (e.g., diabetes) known to accompany such medication, the opportunity calculator could identify the absence of such diagnosis as an anomaly. The opportunity calculator thus can identify each anomaly as problem list codes, DRG information or the like, which may not have been documented or billed based on comparing billing data or documentation data, respectively, to corresponding surrogate data. The output can include text identifying the possible missed opportunity (e.g., by code or other descriptor) and/or an indication of a number of possible missed opportunities for each of one or more providers. In some examples, the opportunity calculator can also determine a likelihood of each missed opportunity by employing descriptive statistics. The outputs can be aggregated for each provider for providing a comparison over a user-defined time period, such as disclosed herein.

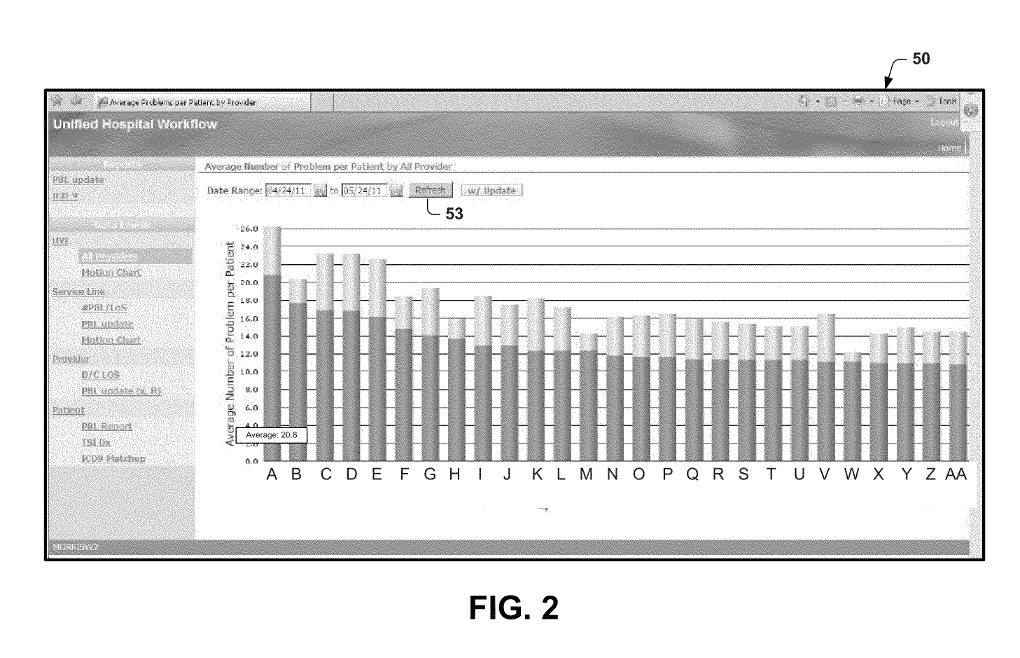

FIGS. 2-16 demonstrate example embodiments of GUIs (e.g., corresponding to the GUI 22 of FIG. 1) that can be generated by the system 10 of FIG. 1, such as corresponding to different configuration parameters (e.g., selected via parameter selection component 20 of FIG. 1) in response to user inputs. In the examples of FIGS. 2-16, certain proprietary or sensitive information has been redacted from several of the figures. It will be appreciated that the form and GUI elements provided in examples of FIGS. 2-16 are for illustrative purposes and that this disclosure relates to the underlying analytics and content being presented (e.g., as computed by the system 10 of FIG. 1). Thus, the system of FIG. 1 can employ different types and forms of GUIs that that shown in the examples of FIGS. 2-16 to facilitate problem-oriented charting.

FIG. 2 depicts an example of a graphical user interface 50 demonstrating an average number of problems per patient for a set of providers, such as can be computed by the calculator 18 of FIG. 1. The set of providers can be selected, such as ranging from all providers or a selected subset of one or more available providers, such as may correspond to a predefined group or service line. Thus, the GUI includes a variety of data levels that can be selected by a user. In the examples of FIGS. 2-16, the data levels are demonstrated as including HVI, such as corresponding to the enterprise level, a service line data level corresponding to a selected department or a group of providers, a provider data level (corresponding to an individual provider) and a patient data level in which data can be presented for one or more patients. Additionally, the providers are identified generically by letters, where in other examples actual names can be used. A selected date range can be set, such as in FIG. 2 for demonstrating an average number of problems per patient for each of the selected set of providers over the selected date range. The set of providers can be expanded or contracted in the display such as by scrolling through the set of providers that are presented. GUI elements can also provided in the GUI 50 for activating additional features, such as, for example, including for setting the date range, a refresh button or a “w/update” button 53. Alternatively, or additionally, functionality can be implemented to allow for dynamic exploration of data with plural interacting views based on this disclosure. Multiple colors or other graphical differentiators can be used to display statistical data computed for the GUI 50, such an average number of patients and a corresponding standard deviation.

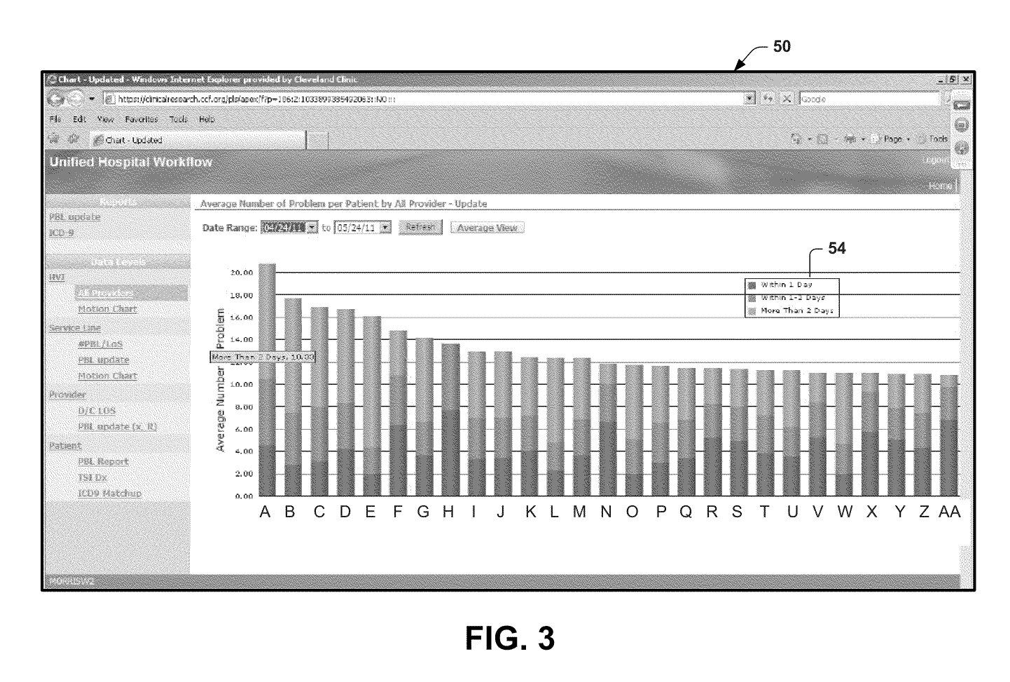

FIG. 3 demonstrates the example GUI 50 of FIG. 2 in which the “update” button 53 has been activated. In response to activating the “update” button 53, as demonstrated in FIG. 3 (or via automated, dynamic updating), information representing the timing of updates of for problems in the problem list is also included for all providers in the selected data level. For example, a color-coded scale 54 can be provided to visually represent the average update time for problems, such as including updates within one day, within one to two days, or for more than two days. The scale 54 allows a user to understand the average update time for each of the listed providers. This additional update timing information can be presented in (e.g., superimposed on) each of the bars that visually represent the statistics that have been computed (e.g., by the analytics engine 16 of FIG. 1) for each of the providers.

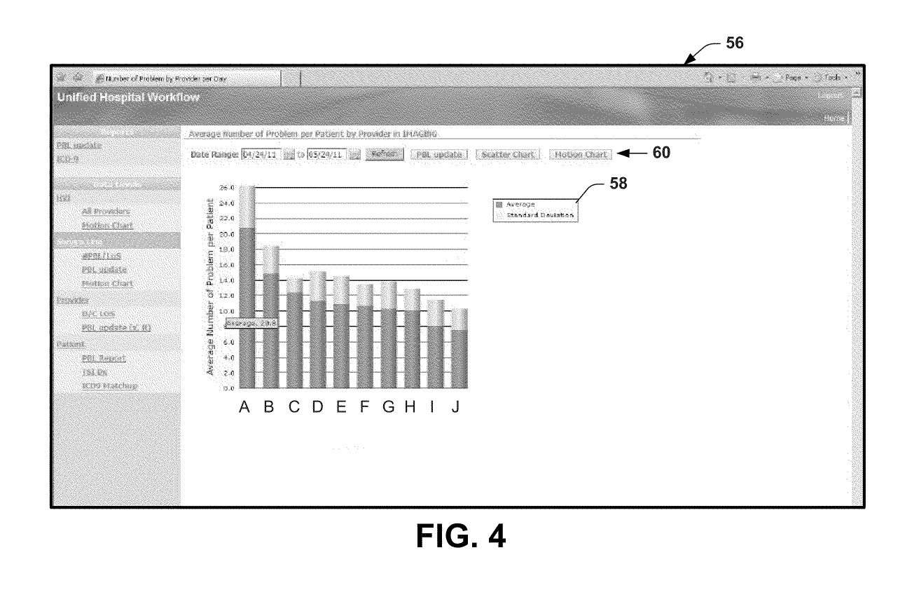

FIG. 4 further illustrates an example of another GUI 56 that can be generated by the output controls (e.g., output controls 48 of FIG. 1) based on computed analytics. In the example of FIG. 4, the GUI 56 demonstrates an average number of problems per patient for a selected service line based on analytics (e.g., computed by the analytics engine 16 of FIG. 1), which is in this example is an imaging service line. As demonstrated in FIG. 4, an average number of problems and standard deviation are graphically represented in the GUI 56 by different colors, as indicated by the scale 58, for each provider in the selected service line. The GUI 56 also includes a plurality of GUI elements 60 that can be activated to access additional functions and tools, such as including a “refresh” button, a problem update (“PBL update”) button, a “scatter chart” button and a “motion chart” button. Each of these GUI elements 60 may be activated in response to a user input (or automatically in other modes) to change the output controls and the manner in which the information is being presented. For example, the “PBL update” button can be activated to include the update timing information for each of the providers for each of the patients. A scatter chart can represent a scatter chart and the motion chart button can be utilized to provide an animated output of the information within a user-selected time period. Thus, by breaking down service line, details associated with specific providers in that specific line of service can be presented in the output that is displayed to the user. In this way, an administrator can easily identify a potential under performer in the group—such as corresponding to insufficiently documenting problems in a problem list for patients.

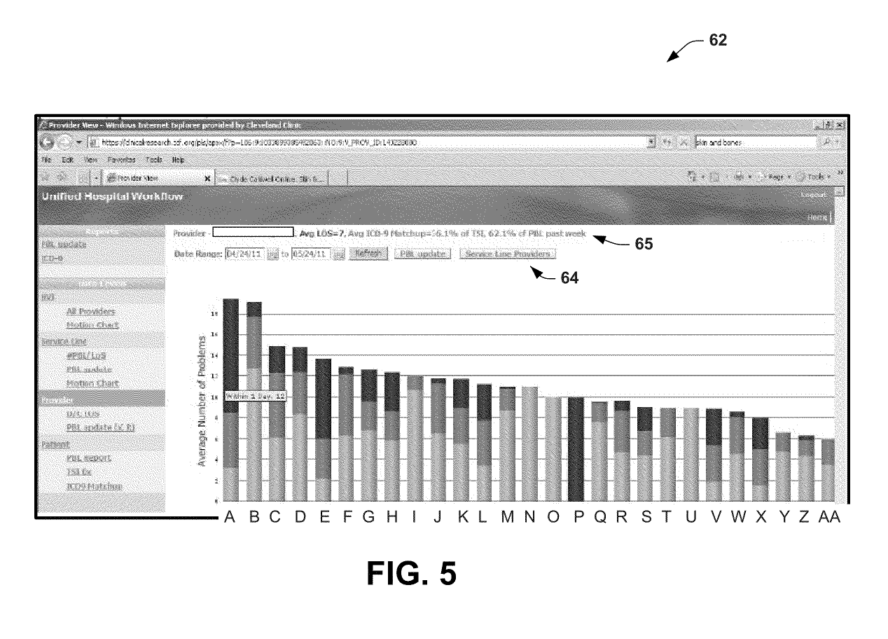

FIG. 5 depicts an example of a GUI 62 demonstrating a patient level aggregate view by providers, such as by setting the data level to the provider level for a selected date range. In this example, a given provider (e.g., Smith, K.) has been selected from a list of providers, and descriptive statistics are computed (e.g., by the analytic's engine 16 of FIG. 1) for such provider over a selected date range and presented via the GUI 62. The visualized statistics include the average number of problems at a patient level view in which a provider can see all of his or her patients in one view as well as the average number of problems for each patient as well as an indication of the health associated with each patient. For example, by hovering over the graphs (e.g., with a cursor or other pointing element), additional information about the update timing for a given problem can be presented to the user. The GUI 62 of FIG. 5 also includes additional GUI elements including a “refresh” button, a “PBL update” button and a “service line providers” button. Each of these GUI elements may be activated to access additional function for presenting additional information. The GUI 62 can also present descriptive statistics 65 for the selected parameters (e.g., the provider, date range and the provider's patients) that can be computed by the calculator 18 of FIG. 1. In the example of FIG. 5, the descriptive statistics 65 include an average length of stay, an average match-up between the ICD-9 codes entered by the provider and the final billing codes according to severity index, as well as the percent of problems that have been documented in a recent period of time (e.g., the past week).

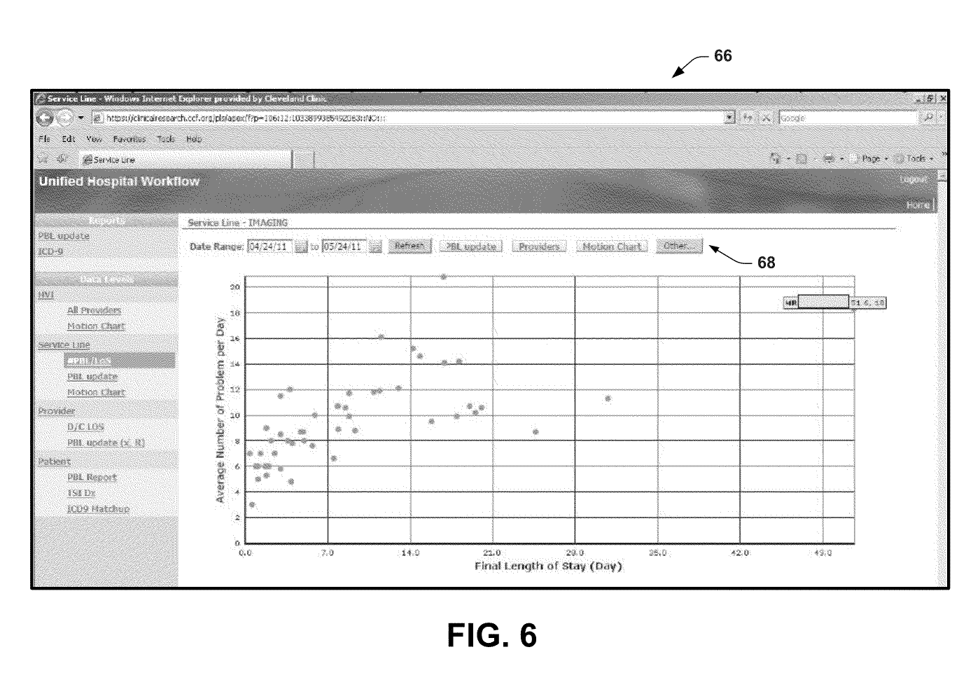

FIG. 6 depicts an example of a GUI 66 demonstrating an average number of problems per day given a final length of stay for a selected service line in a respective enterprise (e.g., as computed by calculator 18 of the analytics engine 16 of FIG. 1). In the example of FIG. 6, the service line has been selected as imaging. As disclosed herein, the service line as well as other parameters may be selected (e.g., via the parameter selection component 20 of FIG. 1). The example GUI 66 contains a scatter plot demonstrating the average number of problems per day as a function of the final length of stay. As can be seen in the graph, outliers can easily be identified and addressed by a user. For example, if a provider has a high length of stay but low number of problems, a user can select the plotted data in the GUI 66 and drill down (e.g., by double-clicking the data element in the graph) to obtain more detailed information associated with the underlying data. The GUI 66 of FIG. 6 can also include GUI elements, such as in the form of buttons including a refresh button, a “PBL update” button, a “providers” button, a “motion charge” button as well as an “other” button, which can be utilized to access other functionality associated with the system. Thus, the graph visually depicts underlying behavioral data for the providers in the given service line over a selected time period.

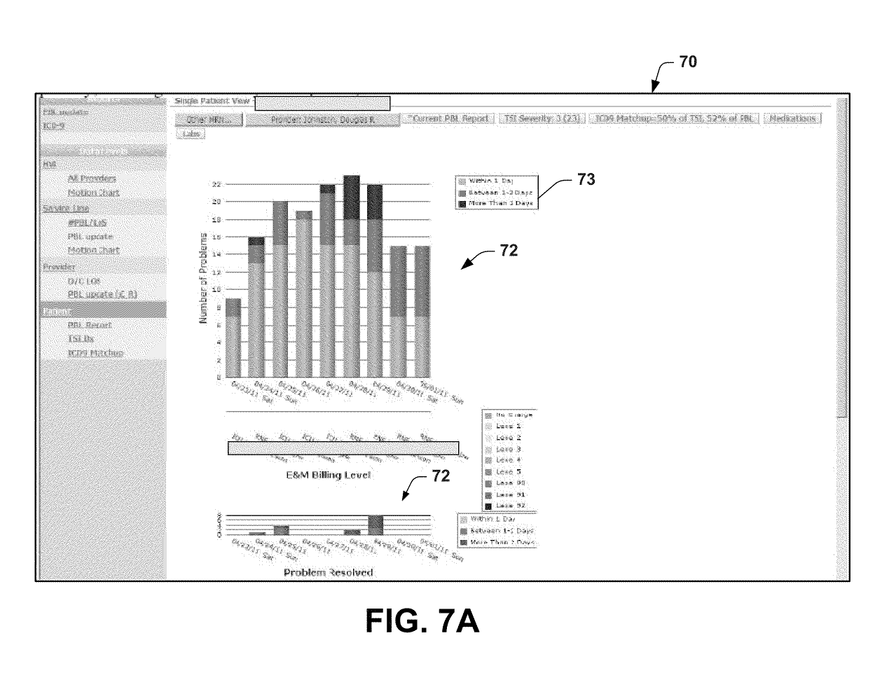

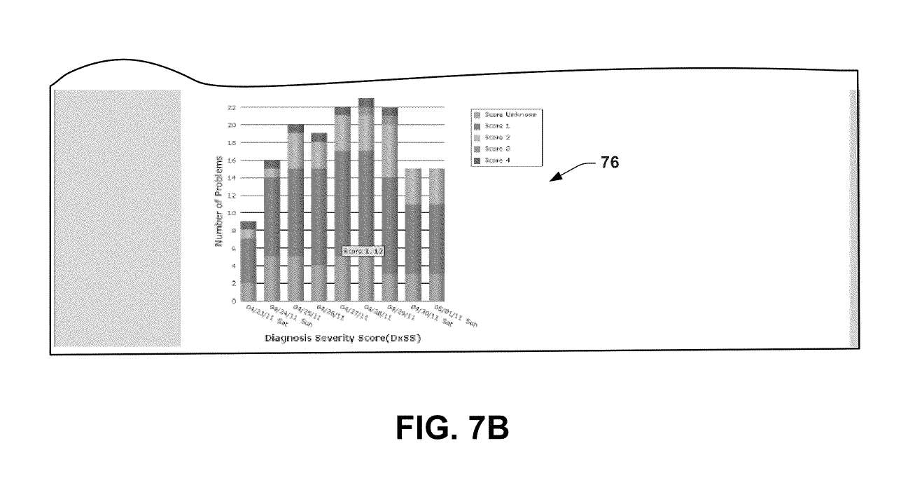

FIGS. 7A and 7B depict an example GUI 70 of statistics for a given patient (Patient X) over a selected length of stay (e.g., computed by the analytic's engine 16 of FIG. 1). For example, the GUI of FIG. 7A demonstrates a bar graph 72 of a number of problems documented for each day for the given patient including the update date associated therewith via a color-coded legend 73 demonstrating the update period, such as demonstrated as being updated within one day, updated between one or two days or more than two days for updating a respective problem. The problem resolution is also depicted in a bar graph 74 for each day, which visually represents the number of problems resolved and the time in which such problems were resolved. Thus, the graphs 72 and 74 visually depict underlying behavioral data for providers treating a given patient, such as computed by the calculator 18 of FIG. 1. For instance, a provider can employ an EHR client to document a change in status for a problem (in a problem list) to resolved or otherwise update the problem, and the calculator can access the EHR data to determine the descriptive statistics from the EHR data for the given patient over the selected date range.

FIG. 7B demonstrates another graph 76 of output statistics that can be computed for the given patient in which the number of problems is plotted for the length of stay and including a diagnosis severity score associated with the problems that are plotted for each day. For example, the GUI of FIGS. 7A and 7B can allow a user to drill into details for each patient to view additional patient specific information for the length of stay. As demonstrated, this can include the number of problems that are updated per day, evaluation and management billing data per day, diagnosis severity score per day. Thus, the graph visually depicts underlying behavioral data for problem-oriented documentation by providers.

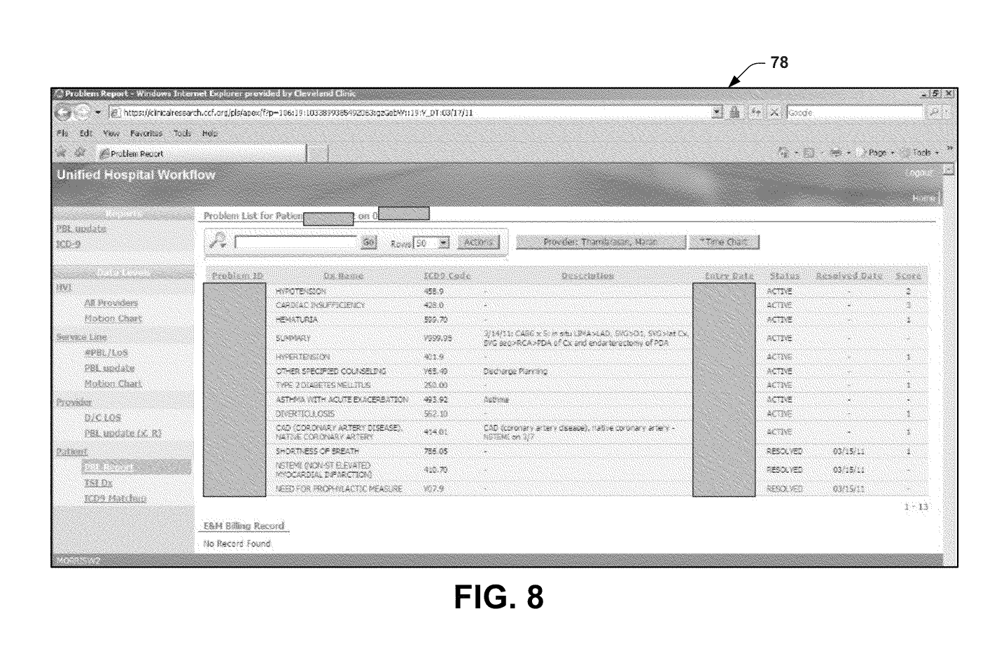

FIG. 8 depicts an example of a GUI 78 demonstrating additional details that may be accessed via the system of FIG. 1 for a given patient. In the example of FIG. 8, the GUI demonstrates a problem list detail report for a given day, such as can be accessed from the GUI 70 shown and described with respect to FIGS. 7A and 7B. Thus, in the example of FIG. 8, a detailed list of problems by diagnosis name and corresponding ICD-9 Code can be provided. The evaluation and management (E&M) data for a billing record can also be provided when such data exists. Thus, by reviewing the detail information a user can ascertain information about the underlying evidence and data utilized in calculating the statistical information that are provided in the other GUIs, thereby understanding provider behavior in greater detail.

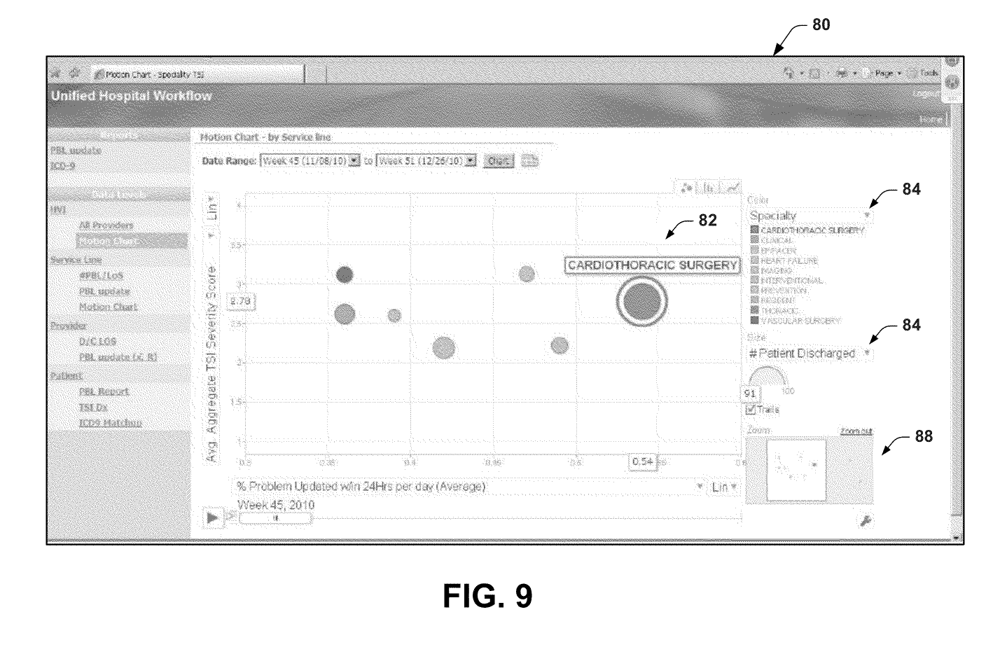

FIG. 9 depicts an example of a GUI 80 demonstrating a motion chart 82 for a given enterprise. In the example of FIG. 9, the motion chart 82 can be generated by plotting the average aggregate severity score for different service lines (e.g., area of specialization) as a function of the percentage problems that are updated within a selected period of time (twenty-four hours per day) as an average. It will be understood and appreciated that the information contained in the axes can be modified and user-selected to present additional types of information in the motion chart, such as by drop-down menus 84 or other GUI elements demonstrated in the example of FIG. 9. The motion chart 82 can also include a color-coded representation by specialty, although other types of information can be demonstrated via color coding.

In the example of FIG. 9, the motion chart demonstrates statistics by service lines in the enterprise, which are demonstrated by specialty, including cardiothoracic surgery, clinical, EP/pacer, heart failure, imaging, interventional prevention, resident, thoracic and vascular surgery. The size of the icons or graphical elements for each such specialty can also vary based upon user selected criteria, which in the example of FIG. 9 is demonstrated as the number of patients discharged on a given day. Additionally at the bottom of the motion chart 82 is a temporal GUI element 86, such as demonstrated in the form of a slide, which indicates the time (e.g., day or hour) in the selected date range corresponding to the information that is presented in the motion chart 82. For example, a user can select a play button to activate the motion chart to provide the animated visual representation to the user, pause the chart or otherwise move the slide element back and forth to select a period of time and view relationships and thereby understand how the data changes over time. A user can also change the date range represented in the data.

In the lower right hand corner of the GUI of FIG. 9, the GUI 80 can present a miniature complete view of the data 88 demonstrating that the data represented on the main plot may not include all of the data calculated such as outliers that may be represented outside the particular scale or zoom level. For instance, a user can activate user interface elements to zoom in or zoom out to change the amount of data and the relative size of the data being illustrated. Thus, the motion chart visually allows a user to understand underlying behavior of selected service lines based on analytics computed (e.g., by the analytics engine 16 of FIG. 1) which can change over time.

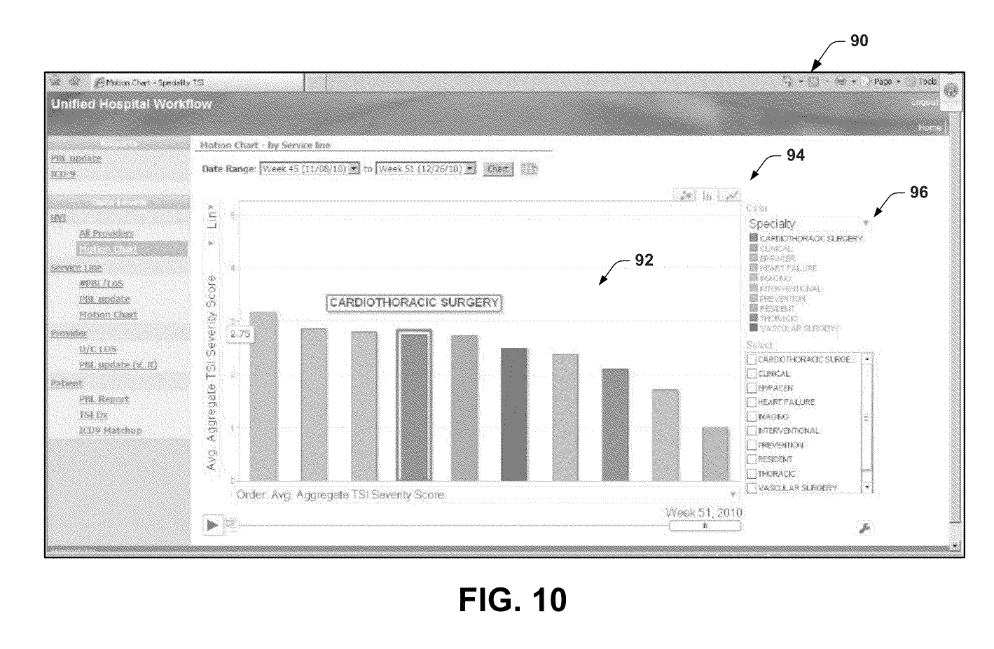

FIG. 10 demonstrates an example of a GUI 90 demonstrating a motion chart by service line similar to the example shown and described with respect to FIG. 9. In the example of FIG. 10, the data is represented as a bar graph 92. The type of motion representation (e.g., scatter plot, bar graph or time based trend plot) can be selected in response to a user input via user interface elements associated with each type of plot, demonstrated in the upper right hand corner of the graph at 94. Other parameters associated with the motion chart 92 in the example of FIG. 10 can also be selected by the user, such as disclosed above with respect to FIG. 9. In the bar graph GUI 90 of FIG. 10, an additional user interface element 96 is provided for setting display parameters, such as select one or more service lines for the motion chart GUI of FIG. 10. The information represented by each bar for each service line will vary over time based upon the point in time during the selected date range in which the chart is shown, as reflected by the temporal GUI element 98 that. Thus, each of the bars in the graph 92 can be animated as the time advances or reverses within the user selected date range.

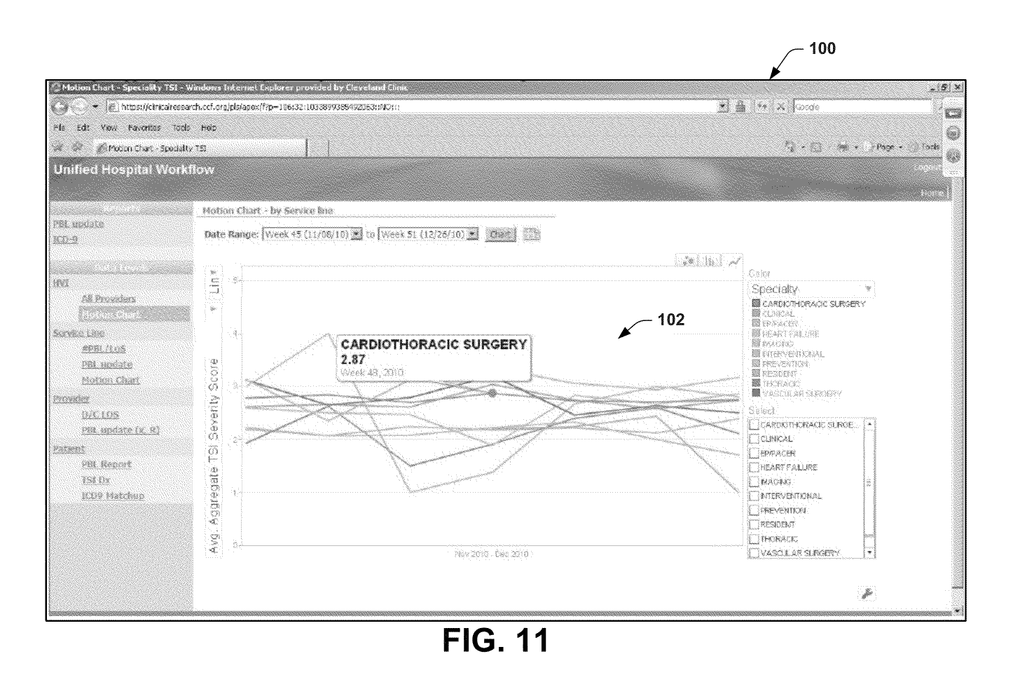

FIG. 11 depicts an example of a GUI 100 demonstrating yet another type of motion chart 102 by service line in which trending is demonstrated for each service line. In the example GUI 100 of FIG. 11, color coding can be utilized to differentiate the different service lines. In this example, the trending demonstrates a global view of the data over the selected date range for each of the service lines. The example of FIG. 11 demonstrates the average aggregate severity score per service line over time. The trending for each service line can be easily identified for a service line associated with the severity score or other criteria that may be selected in the GUI (e.g., via the drop-down user interface element for selecting what parameters to utilize for computing the output statistics represented in the graph). Additionally, a user can hover over a corresponding output that is presented in the motion chart 102 to provide additional information, which in the example demonstrates a point along the plot for cardiothoracic surgery severity plot showing an average severity score of 2.87 for week 48. Additional information may be obtained by drilling down and activating additional functions, such as disclosed herein.

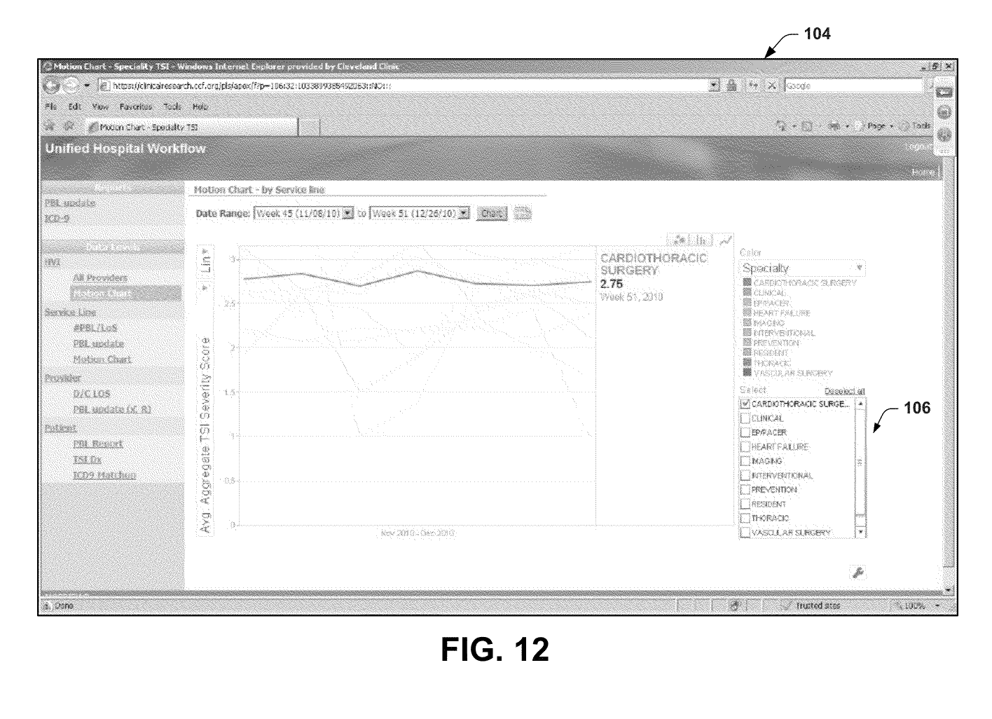

FIG. 12 demonstrates an example of a GUI 104 demonstrating a selected service line that has been isolated from the other service lines from the example of FIG. 11, such as response to a user input selecting the isolated service line via a pointing element or other input device. In the example of FIG. 12, the cardiothoracic surgery service line has been isolated from the other information, such as by selecting the cardiothoracic surgery service line from a list of available service lines for the enterprise (e.g., corresponding to GUI elements 106 in the lower right hand corner of the graph in which cardiothoracic surgery has been selected). Once a service line or a set of service lines has been isolated, more specific details can be obtained by drilling down to the different points along the graph.

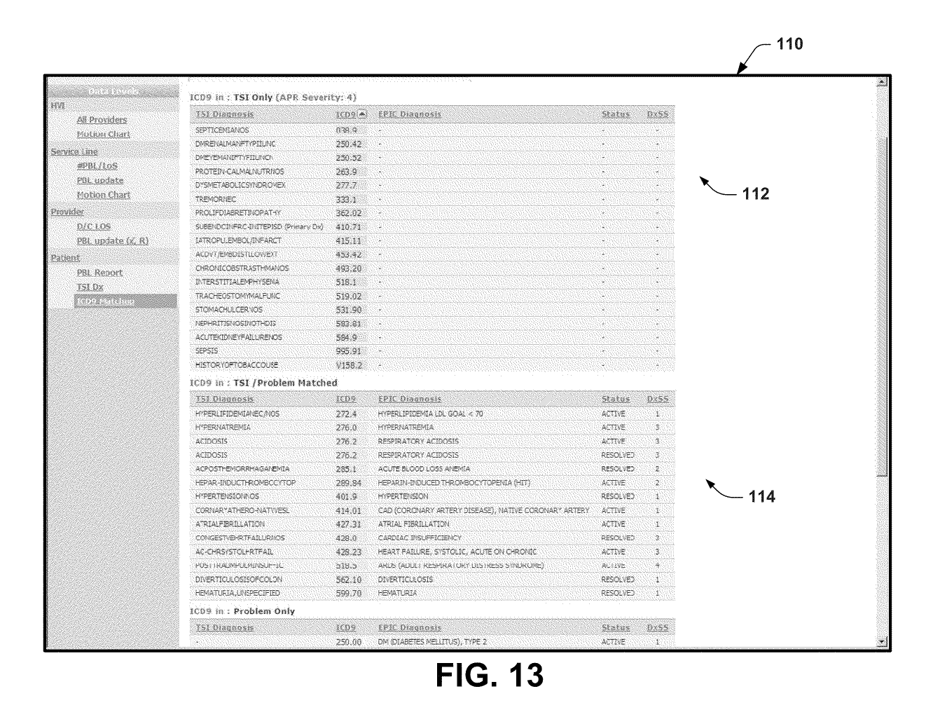

FIG. 13 depicts an example of a GUI 110 demonstrating comparative statistics that can be generated based on enterprise data, including billing data and EHR data. The information presented via the GUI 110 in the example of FIG. 13 can be referred to as a documentation opportunity report. A documentation opportunity report can be generated based on analytics comparing related documentation data with related billing data for a given provider or group of providers. The documentation opportunity report can include information identifying one or more instances of missed opportunities due the detected anomaly (or anomalies) in the documentation. Once the missed opportunities are identified (e.g., by the analytics engine 16 of FIG. 1), the system may also report on the potential cost of the detected inaccurate documentation. For example, the potential cost can be utilized for administrative purposes and help providers change their future behavior, which behavior can also be evaluated via analytics quantitatively over time.

In the example of FIG. 13, the GUI 110 includes a report 112 of coded diagnoses based on coded billing data that do not have corresponding match in the problem list diagnoses based on EHR data. The diagnoses included in the report 112 can be filtered according to severity or other relevant parameters. The report 112 thus can be utilized to ascertain which (if any) services were billed under respective billing codes but did not include corresponding documentation for the diagnosis or other service in the patient record. Similarly, the GUI 110 can provide a report of problems from the EHR data that do not match corresponding billing codes for the respective patient encounter. This report 112 can be utilized to ascertain diagnoses and other types of services (e.g., interventions, labs or the like) that may have been provided and documented but did not result in corresponding billing codes for such services.

The GUI 110 can also includes a comparison report 114 for problem list diagnoses (e.g., obtained from the EHR data of 36 of FIG. 1) relative to diagnoses corresponding to final coded billing data (e.g., obtained from billing data 38 of FIG. 1) for a given patient. Based on analytics computed to compare such data, for example, the GUI 110 of FIG. 13 can present information relating to ICD-9 codes in the final coded billing data, a list of ICD-9 codes that demonstrates matches between the final coded billing and the problem list stored in the EHR data and another list in which the ICD-9 codes are listed from the problem list only. The types of information and lists can be user-selectable. Thus, a user can evaluate the respective lists and determine where they match and where they do not match such as to be able to identify potential missed opportunities in the coding that was entered. This can provide a detailed report to allow a user to automatically view problem list diagnoses entered by a provider (or group of providers) compared to the corresponding billed diagnoses in the final coded data and, in turn, understand where such diagnoses match and where they do not match. As a further example, the analytics can compute the number of times that the final coded billing data does not match the problem list diagnosis from the EHR, such as for each respective provider or group of providers. The computation can be performed for a given patient encounter or over a predetermined time period or both. The comparison can be initiated by a user (e.g., manually) and/or the comparison can be an automated process that generates a corresponding documentation opportunity report for the given provider or a group of providers, such as a service line or an entire enterprise.

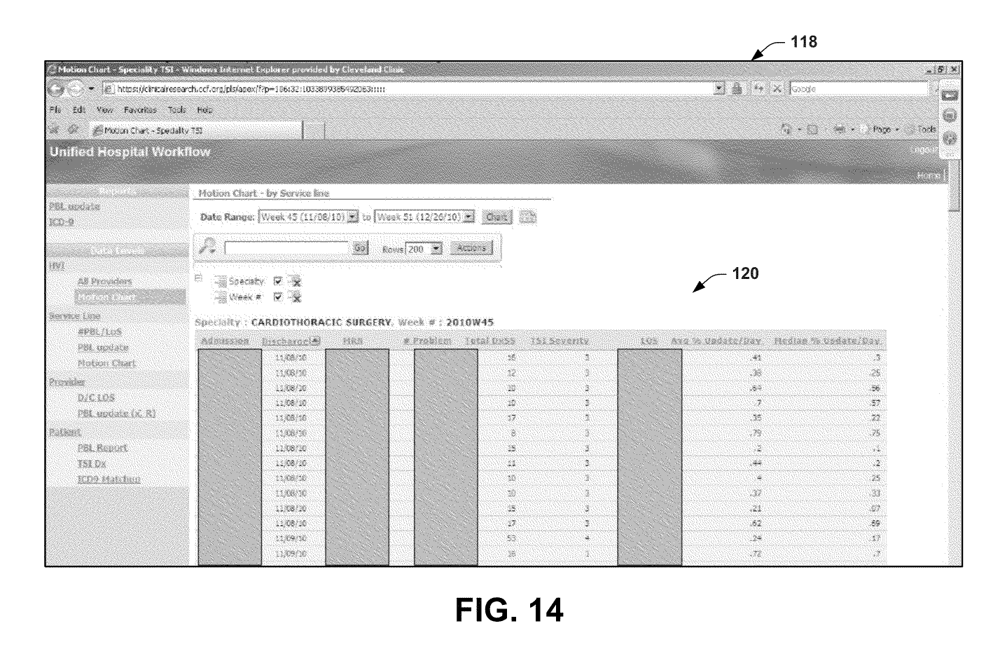

FIG. 14 depicts an example GUI 118 demonstrating a sample report 120 that can be generated. For example, by clicking on a report button 121 from the GUI, a set of problem list data or other information can be identified for all patients based upon user-selected criteria, such as including specialty/service line as well as the data range. The various columns within the table can be sorted to provide details ordered as selected by the user. The report 120 can include statistics that can be computed (e.g., by the analytics engine 16 of FIG. 1) for each patient in the selected range as well as other quantified data obtained from the billing data and EHR data. In the example of FIG. 14, the statistics computed and provided in the report 120 can include the number of problems, total number of diagnoses, the length of stay, the average number of problems updated per day (a %) and the median % of problems updated per day.

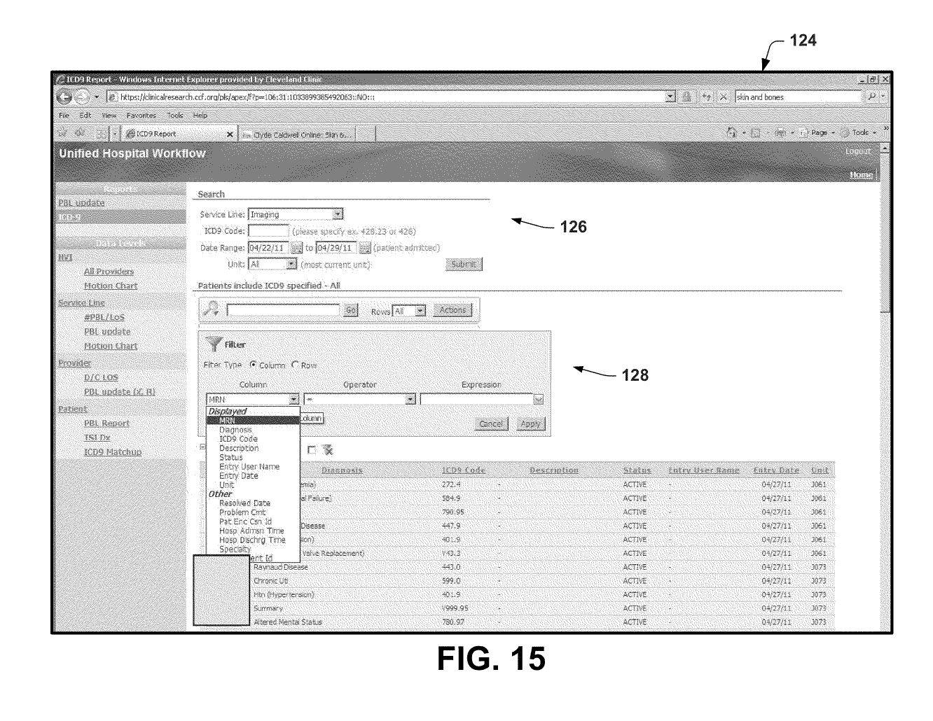

FIG. 15 demonstrates a GUI 124 in which GUI elements 126 and 128 are provided to enable a user to select criteria and filter data according to user selected criteria to create custom reports. For example, the GUI elements 126 can allow the user to set search criteria, such can include defining a service line (e.g., imaging), an ICD code, a date range and units. The search criteria can further be filtered via the filter GUI element 128. The filtering can employ Boolean logic and operations or other expressions that can be selected and defined by the user to create a corresponding filter for the report. Similar filtering can be implemented with respect to the other GUIs disclosed herein (e.g., including in each of FIGS. 2-14 and 16-19).

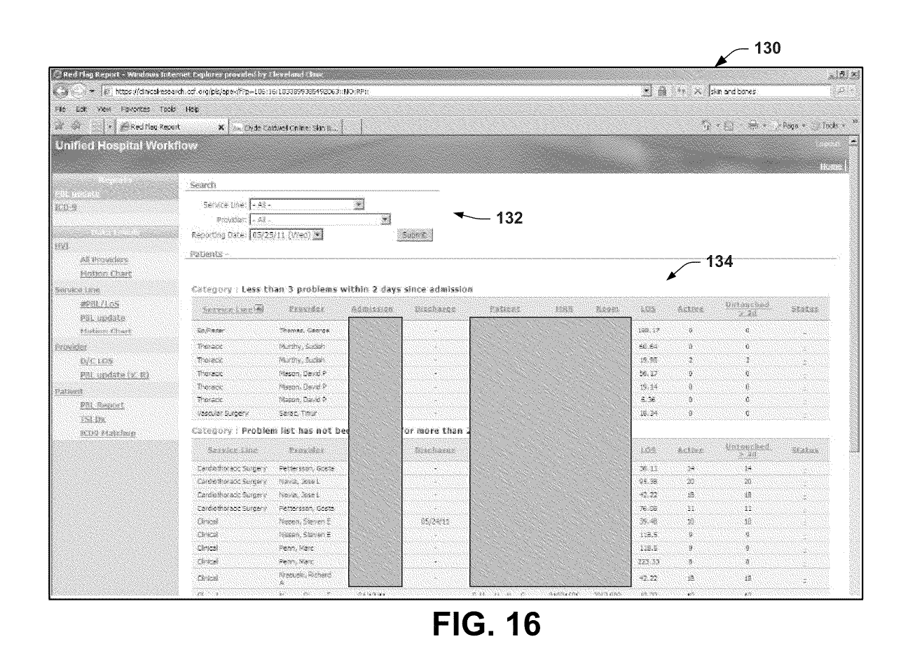

FIG. 16 depicts an example GUI 130 demonstrating another form of behavioral report 134 that can be utilized to provide a warning or alert to the user when provider (or group) documentation behavior is outside of expected operating parameters, which can be user defined parameters (e.g., institutionally accepted norms). The GUI 130 can include GUI elements 132 to define search criteria based on which the report 134 is generated. Analytics can be performed on the search results to compute instances that fall outside of the user-defined expected operating parameters corresponding to one or more different categories of issues/information being reported. The categories can include a predetermined set of alert categories, which can be selected according to user requirements. A user can also create new alert categories by configuring one or more filters, such as disclosed herein with respect to FIG. 15. Based on the analytics computed for each given category and search parameters, output controls can in turn generate a corresponding report that provide information and statistics for the respective alert categories based on the analytics performed.

As an example, the report 134 can be generated to include issue categories that identify problems matching user-defined criteria. For example, an issue category can identify patients admitted for a predetermined period of time (e.g., greater than 24 hours) but with no documented problems or less than a user-defined threshold number of problems reported in the EHR data. As another example category can identify a set of problems have remained on a problem list without any update or resolution within a predetermined period of time (e.g., greater than about 48 hours). The GUI 130 can also allow a user, such as an administrator or supervisor, to drill into the displayed data to obtain additional details about one or more selected part of the information presented in the report 134.

As demonstrated in the example of FIG. 16, different alert categories can be reported based on user-defined report parameters. This type of alert report can be utilized to identify situations in which a provider may be providing insufficient documentation (e.g., in an EHR system) to warrant a particular course of treatment as evidenced by the length of stay exceeding a period of time during which problems have existed without being updated by a provider.

It will be understand and appreciated that other types of parameters can be set for various types of alert reporting based on the enterprise data (e.g., EHR data and billing data) that has been taped for patients and the providers. Additionally, in response to determining one or more alert condition for a given provider the analytics engine can be programmed to cause a message to be sent to one or more individuals, such as via email, a text, a page or other messaging technology. The individual can include the provider and/or a supervisor of the provider for which the alert has be determined. Depending on the technology, the alert message can include a relevant report data and/or a link to enable the recipient (e.g., provider) to update the record, if appropriate.

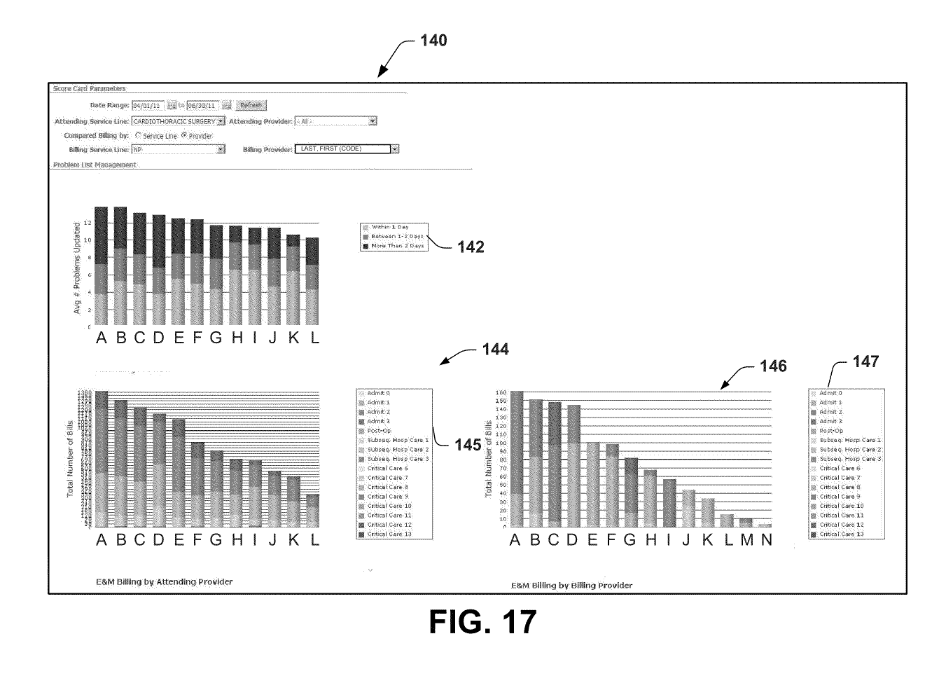

FIG. 17 depicts an example of a GUI 142 corresponding to configurable score cards 142, 144 and 146 that can be generated to report on one or more providers' problem-oriented documentation. Such score cards can provide comparative statistics for one or more providers, such as relative to industry standards, relative to a defined peer group of providers (e.g., within a service line or other subset of providers). Additionally or alternatively, the comparison can be for provider relative to his/her self (e.g., for different time windows). The parameters used in such comparative statistics can be defined by the user or selected from a predefined set of parameters via a user interface element (e.g., drop down menu or the like, such as via parameter selection function 20 of FIG. 1).

In the example of FIG. 17, three score card reports 142, 144 and 146 are shown. One report card 142 includes a graph corresponding to an attending provider graph for graphically presenting an average number of problems updated per day. Color coding of the bar graph, as indicated by color scale 143, also provides an indication of how soon each respective provider updates problems that have been documented (e.g., within one day, within 1-2 days. Another report 144 includes a graph of E&M billing by attending provider (located below the attending provider graph 142). The report 144 demonstrates a total number of bills for each provider in a selected service line, which in this example is a cardiothoracic surgery line. Color coding can also be utilized in the bar graph for each provider, as indicated by color scale 145, to show a distribution of the type bills for each of the providers. The GUI 142 can also include a report 146 that includes a graph of E&M billing graph by billing provider presenting the total number of bills for each provider in a nurse practitioner (NP) service line. The report 146 can also utilize color coding for each provider, as indicated by color scale 147, to show a distribution of the type bills for each of the providers. In the report 146, the names of all providers except one have been replaced by predefined generic indicators (e.g., “***”) such as to provide a level of anonymity for the other providers in the comparative example. Thus, the report can be sent to the selected and listed provider to provide a comparative example, without revealing the identity of the other providers.

Several parameters for the score card GUI 142 can be set via user interface elements (e.g., dialog boxes, drop down menus, buttons or the like) 140. For instance, user interface elements 140 allow for setting a user-selected date range for the score card. Parameters can be set via the GUI elements 140 to select both attending and billing services lines (and/or others) as well as one or more providers in each of the selected lines. In this example, all attending providers have been selected in the attending service line (cardiothoracic surgery), and comparison has been selected to compare by provider. The billing service line has been set to NP and a single selected provider can be set as the billing provider. In this way, anonymity is maintained for each other billing provider (other than the selected billing provider) such that comparison is easily made. This type of score card can be sent via a messaging system to the selected provider or other authorized person to provide a comparative metric of such provider relative to others in their service line.

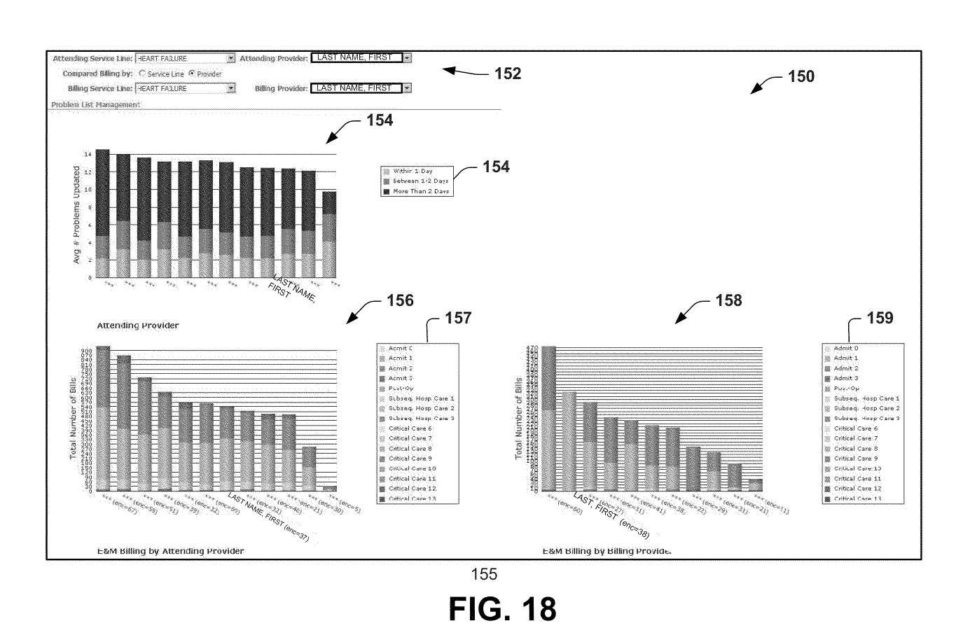

FIG. 18 depicts another example of a score card GUI 150 in which both the attending and billing service lines are the same (“heart failure” in this example), as selected via GUI elements 152. In this example, an attending provider problem update graph 154 is generated (e.g., by analytics engine 16 of FIG. 1) for a selected provider in the service line while the other providers in this service line are shown by asterisks similar to the graph 146 of FIG. 17. Such a report and graph thus can be sent (e.g., via a message service) or delivered as a printed report to the identified provider so that the provider can see how such provider's problem-oriented charting and related billing compares to other employees in the same service line without revealing the identity of each other provider. An E&M billing by attending provider graph 156 also demonstrates the total number of bills and other color coded bill type information for the same selected provider as well as comparisons with other providers in the service line (with their names replaced by asterisks). An E&M billing by Billing Provider graph 158 also demonstrate the total number of bills for each provider in the selected service line to provide a comparative example for the selected billing provider. Thus, the score card 150 provides an effective tool that can be generated (e.g., by the output controls 48 of FIG. 1) to encourage improvements in accurate problem-oriented documentation by the provider.

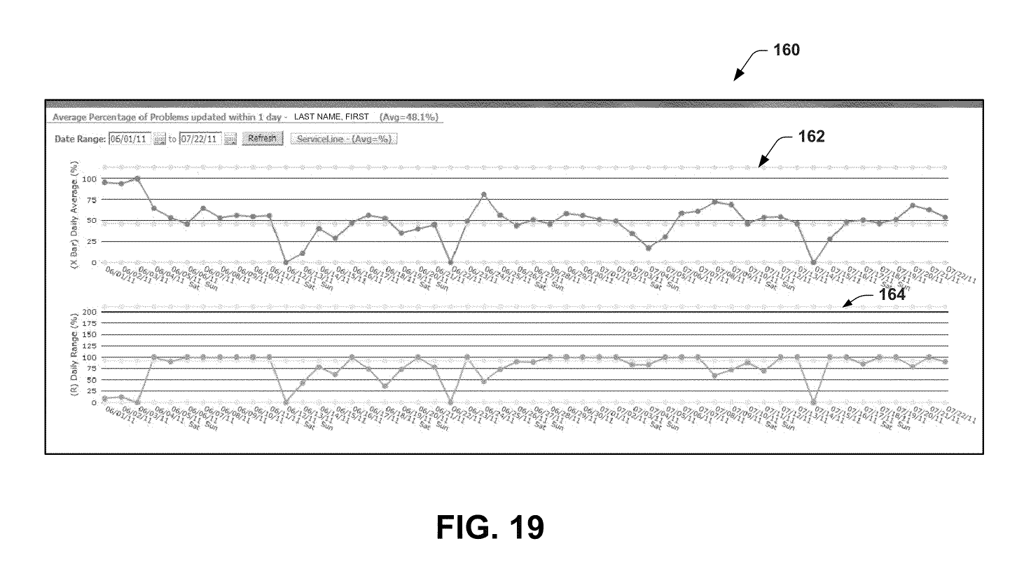

The systems and methods disclosed herein can employ control charts to monitor data collected for one or more variables related to documentation and problem lists that are enter by or on behalf of a provider. The example of FIG. 19 depicts a GUI 160 demonstrating statistics in the form of an x-bar chart 162 and R-chart 164 related to a frequency at which a given provider documents healthcare services being provided. Such statistical metrics, while relatively common in industrial controls, provide unique information relative to documentation and billing behaviors. The GUI and corresponding reports 162 and 164 can thus be utilized to provide behavioral information for one or more healthcare providers, such as can include documentation behavior and corresponding billing behaviors for each such provider.

In the particular example of FIG. 19, the GUI 160 provides a graphical representation of a daily average and a daily range (in average percentage) related to a frequency that a given provider updates problems that have been documented. Similar charts can be generated for other documenting-related criteria—for one or more providers. The GUI 160 can also include a date range user interface element to select (in response to a user input) a range for types of data being represented in the respective graphs.

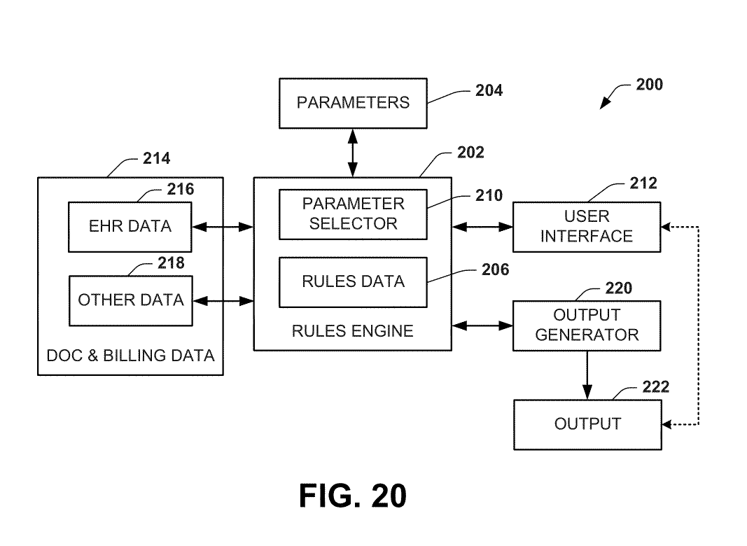

FIG. 20 depicts an example of a rules-based tool 200 that can be employed to facilitate assessing documentation and billing behaviors of one or more providers in an enterprise (e.g., in a healthcare or other service oriented enterprise). The tool 200 includes a rules engine 202. The rules engine 202 can be programmed for creating and configuring rules (e.g., expressions) to evaluate and identify useful parameters 204 for assessing documentation and/or billing behaviors. The rules engine can be implemented, for example, are part of or otherwise utilized by the analytics engine 16 of FIG. 1 for computing the various calculations disclosed herein. For example, selected rules can be stored in memory, as the parameters 204, which can be selected (e.g., by the parameter selector 20 of FIG. 1) and utilized (e.g., by the calculator 18 of FIG. 1) for generating corresponding outputs as disclosed herein.

The rules engine 202 includes rules data 206 that define rules that can be selected by a parameter selector 210 for execution by the rules engine. The tool 200 can include a user interface 212 that can be used for defining expressions corresponding to rules defined by the rules data 206. For example, the user interface 212 can include a plurality of fields that define expressions, such as the type of patient data, provider data, service line data, the manner of sampling such data (e.g., date range, groups or service lines, thresholds or the like), that can be applied by the rules engine 202 to relevant documentation and billing data 214, such as disclosed herein. The expression can include a single expression or it can include multiple expressions, which may be nested expressions. Each expression can be configured individually according to criteria defined via the user interface 212. Each expression and each rule can employ Boolean logic as well as other mathematical and logical means of combining variables and expressions for calculating outputs based on the documentation and billing data 214 according to the selected rule parameters.

The documentation and billing data 214 may include EHR data 216 or other data 218. Such data may be real time data or a replicated copy thereof, such as may be stored outside an EHR system for analysis (as to avoid excessive loading of the EHR system). The other data 218 may include stored information related to providers, billing (e.g., final coded billing data), patient care or data derived therefrom (e.g., by healthcare dash-boarding systems or the like). Thus, the rules engine 202 can apply user-defined rules to a variety of different types of data to assess documentation and billing data 214 generated by one or more providers as disclosed herein. Such a rules engine 202 affords great versatility to a user for exploring and understanding relationships between related documentation and billing data, for example. The exploration of and understandings developed therefrom can be employed to define parameters (e.g., rules) that can be used by the systems and methods disclosed herein (e.g., FIGS. 1-19).

As part of such exploration, the system 200 can include an output generator 220 to generate a corresponding output 222 representing the computations by the rules engine on the data 214 according to user-defined constraints. The output 222 can also include a GUI that presents the information to a user. The types of outputs can be of the types or similar in kind to those shown and disclosed herein (see, e.g., FIGS. 1-19). The output 222 can be generated within the context of the user interface 212, and may be dynamically updated (e.g., in real time or near real time) in response to user inputs changing one or more constraints. As a result, a user has great flexibility in defining constraints that control how data is selected, sorted, compared or otherwise used in calculations performed by the rules engine 202. Based on a user's experience with the output and information provided thereby, selected rules and constraints associated with such rules can be stored as the parameters 204 as in response to a user input. The parameters 204 can, in turn, be employed in workflows to provide user-configurable tools and comparative statistics related to documentation and/or billing, including relevant behavior of providers, based on the teachings herein.

As will be appreciated by those skilled in the art, portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system comprising:
memory to store computer executable instructions and enterprise data, the enterprise data comprising customer data representing information to document services rendered by a given enterprise provider for each customer; and
a processor configured to access the memory and execute the computer executable instructions which comprise:
an analytics engine to compute descriptive statistics relating to the services rendered by one or more providers based on customer problems documented by providers in the customer data; and
output controls to generate an output of the descriptive statistics.

2. The system of claim 1, wherein the enterprise is a medical enterprise, each provider is a provider and each customer is a patient, the customer data comprising patient data entered by or on behalf of a given provider, the patient data being stored in an electronic health record (EHR) system.

3. The system of claim 2, wherein the descriptive statistics further comprises statistics representing a number of problems for each respective patient for at least one provider in the medical enterprise.

4. The system of claim 2, wherein the computer executable instructions further comprise a parameter selection component programmed to select parameters employed by the analytics engine to compute the descriptive statistics.

5. The system of claim 4, wherein the parameters define a time period over which the enterprise data is extracted for use by the analytics engine.

6. The system of claim 4, wherein the parameter selection component is programmed to select a data level in response to a user input, the data level being selected from a group comprising the medical enterprise, service line, provider and patient.

7. The system of claim 4, wherein the parameter selection component is programmed to select at least one rule that is applied to the enterprise data by the analytics engine to compute the descriptive statistics.

8. The system of claim 2, wherein the patient data comprises problem list data stored in the EHR system, the problem list data describing at least one of treatment or management of the patient by the given provider.

9. The system of claim 8, wherein the enterprise data further comprises interpreted data representing final coded documentation associated with a patient encounter that is derived based on the customer data entered by or on behalf of the given provider.

10. The system of claim 9, wherein the analytics engine further comprises a calculator programmed to compute a comparative statistic between a selected set of the patient data, including the problem list data, and the interpreted data.

11. The system of claim 10, wherein the calculator is programmed to identify an anomaly in at least one of a documentation behavior and a billing behavior of at least one given provider based on the comparative statistic computed between the set of patient data and the interpreted data.

12. The system of claim 9, wherein the interpreted data for each patient comprises final patient coded data derived from the patient data entered by the provider using a predefined set of possible codes.

13. The system of claim 12, wherein the predefined set of possible codes comprises at least one of International Classification of Diseases (ICD) codes, diagnosis related group (DRG) codes and problem list codes.

14. The system of claim 2, wherein the output controls are programmed to provide an animated graphical representation of the descriptive statistics to visualize changes in the descriptive statistics dynamically over time.

15. The system of claim 2, wherein the output controls are programmed to provide a score card output representation that demonstrates comparative statistics for at least one of a documentation behavior or a billing behavior for at least one provider.

16. The system of claim 1, wherein the analytics engine is programmed to compute the descriptive statistics based on a comparison of the enterprise data corresponding to a documentation behavior with another set of the enterprise data corresponding to a billing behavior for a selected one or more of the providers.

17. The system of claim 16, wherein the analytics engine comprises a calculator programmed to compute a missed documentation opportunity for a user defined category, the missed documentation opportunity being detected based on comparing the enterprise data corresponding to the documentation behavior with the enterprise data corresponding to the billing behavior.

18. A non-transitory medium having machine readable instructions programmed for performing a method comprising:
accessing documentation data, the documentation data including information entered by or on behalf of a healthcare service provider in relation to at least one of patient treatment or management;
computing descriptive statistics for a documentation behavior of the provider based on analysis the documentation data, including the information entered by or on behalf of the provider; and
generating an output that presents a representation of the computed descriptive statistics.

19. The medium of claim 18, the method further comprising accessing interpreted data, the interpreted data representing final coded documentation associated with a patient encounter that is analogous to and derived based on the documentation data,
wherein the computed descriptive statistics are computed based on a comparison of related records from the documentation data and the interpreted data.

20. The medium of claim 19, wherein the interpreted data comprises final patient coded billing data according a predefined set of possible billing codes.

21. The medium of claim 19, wherein the output identifies matches between the information entered by or on behalf of the provider and the final coded documentation.

22. The medium of claim 21, wherein the output identifies matches between the information entered by or on behalf of the provider and the final coded documentation.

23. The medium of claim 19,
wherein the documentation data includes problem list data accessed from a electronic health record system, and
wherein the interpreted data includes billing data is accessed from a billing system for a healthcare enterprise.

24. The medium of claim 18, wherein the output identifies anomalies in the information entered by or on behalf of the provider based on comparing the descriptive statistics to a threshold value.

25. The medium of claim 18, the method further comprising selecting a data level in response to a user input, the data level being selected from a group comprising the medical enterprise, service line, provider and patient, the output including a representation of the descriptive statistics for the selected data level.

26. The medium of claim 25, the method further comprising accessing interpreted data, the interpreted data representing final coded billing information associated that is analogous to the documentation data,
wherein the computed descriptive statistics are computed to identify missed documentation opportunities for the selected data level, the missed documentation opportunities being detected based on comparing the documentation behavior determined from the documentation data with a billing behavior determined from the analogous interpreted data.

27. The medium of claim 18, wherein the output further comprises a score card output representation that demonstrates comparative statistics for at least one of the documentation behavior or a billing behavior for at least one provider.
